(19) United States
(12) Patent Application Publication
(10) Pub. No.: US 2003/0141008 A1
(43) Pub. Date: Jul. 31, 2003

(54) Method for producing laminated glass

(76) Inventors: Andreas Peter Galac, Ansfelden (AT); Gunther Griebel, Halle (DE)

Correspondence Address: FLYNN THIEL BOUTELL & TANIS, P.C., 2026 RAMBLING ROAD, KALAMAZOO, MI, 49008-1699, US

(21) Appl. No.: 10/319,372

(22) Filed: Dec. 13, 2002

(30) Foreign Application Priority Data
Dec. 13, 2001 (DE) 101 61 242.7

(51) Int. Cl. B32B 17/00

(52) U.S. Cl. 156/99

(57) ABSTRACT

For producing laminated glass, a UV-curable casting resin is used with a dye that is no longer visible after curing of the casting resin with UV light.

This invention relates to a method for producing laminated glass, including laminated safety glass, according to the generic part of claim 1.

Laminated glass or laminated safety glass consists of at least two glass sheets connected by an elastic interlayer formed by a casting resin or film. In case of glass breakage the elastic interlayer binds the splinters to the elastic interlayer, thereby avoiding injuries.

As a casting resin a chemically curing, normally multi-component casting resin can be incorporated between the at least two glass sheets and then cured. The curing process normally begins after two to six hours and is completed only after weeks. If a one-component casting resin curable by UV light is used, however, the curing process lasts between about ten minutes and one hour.

UV-curable casting resins contain a UV photoinitiator or photosensitizer that absorbs UV radiation. While the photoinitiator breaks down, the photosensitizer transfers the absorbed energy to another molecule that breaks down. The UV-curable casting resins on the market, usually acrylic casting resins, are placed after casting between at least two glass sheets under a UV light source. The UV light source radiates at a certain intensity in the wavelength range from 200 to 800 nanometers, so that the UV initiator or sensitizer starts the curing. The UV light source is normally positioned only on one of the two glass sheets. After a few minutes the casting resin is cured and the laminated glass can be removed.

The curing of UV-curable casting resin is difficult to control, however. Thus, the fact that the glass used likewise absorbs light waves in the UV range makes it difficult to ascertain precisely when curing is over. This holds all the more as different glass thicknesses are used to obtain different safety levels in the production of laminated glass or laminated safety glass.

The thicker the glass sheet used is, through which the casting resin is irradiated with UV light, the longer UV irradiation must be performed. Also, the layer thickness of the casting resin varies in order to obtain certain safety levels of the laminated glass. Therefore, considerable experience is necessary for performing irradiation that is neither too long nor too short, but even with experience it is practically impossible to determine with any precision the time when the casting resin is cured completely.

A further considerable problem is the shrinkage of the casting resin during curing. With UV-curing casting resin on the market, a shrinkage of up to 18 vol % can occur, which is to be taken into account in the calculation of the required quantity of casting resin. That is, an up to 18% greater volume of casting resin must be incorporated between the glass sheets than constitutes the volume of casting resin after curing. The mechanical properties of the glass sheets used normally cause the laminated glass assembly to bulge in the middle. That is, the casting resin is not distributed evenly over the whole laminated glass surface, but has a greater layer thickness in the middle of the glass. The different layer thickness results in a further impediment for ascertaining the curing time of the casting resin.

The laminated glass surface to be cured may be 15 square meters and more. For curing the casting resin one then frequently uses a device having a plurality of UV light sources under which the laminated glass surface to be cured is disposed. If some of said UV light sources fail, this is frequently only noticed during cutting of the laminated glass surface, the consequence being that the casting resin has not yet cured in the area where a UV light source failed.

The problem of the invention is to ascertain precisely and reliably in simple fashion the time when the casting resin has cured during production of laminated glass where the glass sheets are interconnected by UV light curable casting resin.

This is obtained according to the invention with the method characterized in claim 1. The subclaims render advantageous embodiments of the inventive method.

According to the inventive method, the casting resin contains a photoreactive dye that is no longer visible when the cure of the casting resin with UV light is over. That is, the dye may be a dye that changes from its colored state to a colorless state and/or breaks down into colorless components through the UV light source. The dye is used in the casting resin in such a quantity that the color is readily visible at the selected layer thickness of the resin between the glass sheets. Not only the time of complete cure of the casting resin is indicated by the disappearance of the dye color, but also the course of the curing process due to the decrease in intensity of the color. The cure of the casting resin thus need no longer be based on error-prone empirical values; the complete cure of the resin is indicated optically, independently of the thickness of the glass sheets used, the layer thickness of the resin, etc. In case of colorlessness the user can thus assume a perfect final product.

A great number of dyes can be used as photoreactive dyes. A classification of dyes is stated for example in Ullmann's Encyclopedia of Industrial Chemistry, 5^{th} ed., vol. 9, pp. 73 ff, and Organische Chemie, 1^{st} ed., pp. 743 ff, Deutscher Verlag für Grundstoffindustrie, Leipzig 1985.

The dyes can be divided according to their chemical constitution into the following most important classes:

Anthraquinone dyes

Azine dyes

Azo dyes

Azo annulene dyes

Benzoquinone and naphthoquinone dyes

Quinone imine dyes

Indigo or Indigoid dyes

Methine dyes

Naphthalamide dyes

Nitro dyes

Polymethine dyes

Sulfur dyes

Di- and triarylmethane dyes

Xanthene dyes

The photoinitiator or photosensitizer for curing the casting resin can absorb above all light with a wavelength in the range of 250 to 440 nanometers, preferably 300 to 425 nanometers. In order not to hinder the photoinitiator or photosensitizer in the casting resin, i.e. the photochemical reactivity of the casting resin, the dye used should preferably not have an absorption band wholly or largely within the absorption wavelength range of the photoinitiator or photosensitizer, i.e. the dye should preferably absorb in this wave range at most 50%, in particular less than 10%, of the radiation energy that the photoinitiator or photosensitizer absorbs in this range. The UV light source thus preferably has an accordingly wide wavelength spectrum. That is, it can extend from 200 nanometers into the visible range, e.g. from 200 to 800 nanometers. Preferably a UV light source is therefore used that has high luminosity even in the visible range, e.g. at least 5% of the total radiation energy of the light source.

A great variety of resins can be used as casting resins, for example, (meth)acrylic resin, unsaturated polyester resins (UP), aliphatic and aromatic epoxy (meth)acrylate resins, polyester (meth)acrylate resins, aliphatic or aromatic urethane (meth)acrylate resins, polyether (meth)acrylate resins or vinyl ester resins.

These resins are dissolved in reactive solvents. These may be: styrene, monomers or oligomeric acrylates or methacrylates as well as mixtures thereof.

The inventively used casting resin is formulated from the single components, i.e. prepolymer, solvent, photoinitiator or photosensitizer and dye. The single components are coordinated with each other so that the casting resin is stable in the dark and the dye begins to fade only upon exposure to a UV light source. The fading process is over, i.e. the dye no longer visible, when the casting resin has cured up to a certain degree of cure.

### EXAMPLE 1

1500 grams of commercial acrylic casting resin “Chemetall UV11” containing a photoinitiator is mixed with 0.2 wt % of 3,6-dichlorofluorescein solution (10 wt % dye in ethyl glycol). The casting resin has an intensive light-red color.

The light-red casting resin is cast on a glass sheet and a glass sheet placed thereon to form a light-red casting resin interlayer between the two glass sheets. The assembly formed of the two glass sheets and the colored casting resin interlayer is irradiated with a commercial UV lamp for curing UV-curable casting resin for laminated glass sheets. After 10 minutes the casting resin has gelled, after 20 minutes the color of the casting resin is no longer to be seen. After another 5 minutes the casting resin has the optimal cure.

### EXAMPLE 2

1364 grams of commercial unsaturated polyester resin “Norsodyne E 8166” containing 45 wt % of styrene in the form as supplied is mixed with 136 grams of hydroxypropylacrylate. As a photoinitiator, 1 wt % of commercial “Lucirin TPO” is added to the resin mixture. As an indicator dye, 100 ppm of “Safranin T” is used. The casting resin has an intensively purple color.

From the colored casting resin a colored casting resin interlayer is formed between two glass sheets as in Example 1 and irradiated with the UV lamp.

After 7 minutes the resin has gelled, after 12 minutes the casting resin layer has faded and after 15 minutes the resin laminate has the optimal cure.

### EXAMPLE 3

1500 grams of commercial casting resin “Siglam Standard” is mixed with 0.5 wt % of the photoinitiator “Darocore 1173.” As an indicator dye, 12 ppm of methylene blue is used. Methylene blue is added to the resin as a 3% solution in ethanol and mixed well. The casting resin has a dark-blue color.

From the colored casting resin a colored casting resin interlayer is formed between two glass sheets as in Example 1 and irradiated with the UV lamp.

After 5 minutes the resin has gelled, after 25 minutes the methylene blue has faded and after 27 minutes the laminate has gained the optimal strength.

1. A method for producing laminated glass from glass sheets interconnected by a casting resin curable by UV light, characterized in that the casting resin contains a photoreactive dye that is no longer visible after curing of the casting resin with UV light.

2. A method according to claim 1, characterized in that the radiation energy absorbed by the dye in the resin in the wavelength range where UV light cures the resin is less than 50% of the radiation energy that the resin absorbs in said wavelength range for curing.

3. A method according to claim 1 or 2, characterized in that the dye is at least one dye from the following group:
anthraquinone dye
azine dye
azo dye
azo annulene dye
benzoquinone or naphthoquinone dye
quinone imine dye
indigo or indigoid dye
methine dye
naphthalamide dye
nitro dye
polymethine dye
sulfur dye
di- or triarylmethane dye
xanthene dye

4. A method according to any of the above claims, characterized in that the casting resin is a (meth)acrylic resin, unsaturated polyester resin, aliphatic or aromatic epoxy (meth)acrylate resin, polyester (meth)acrylate resin, urethane (meth)acrylate resin, polyester (meth)acrylate resin or vinyl ester resin.
